(19) United States
(12) Patent Application Publication
(10) Pub. No.: US 2021/0364871 A1
(43) Pub. Date: Nov. 25, 2021

(54) SUBSTRATE AND LIQUID CRYSTAL DISPLAY PANEL

(71) Applicant: Shenzhen China Star Optoelectronics Semiconductor Display Technology Co., Ltd., Shenzhen (CN)

(72) Inventor: Pian XIAO, Guangdong (CN)

(73) Assignee: Shenzhen China Star Optoelectronics Semiconductor Display Technology Co., Ltd., Shenzhen (CN)

(21) Appl. No.: 16/620,546

(22) PCT Filed: Nov. 4, 2019
(86) PCT No.: PCT/CN2019/115447

§ 371 Date: Dec. 9, 2019

(30) Foreign Application Priority Data
Oct. 18, 2019 (CN) 201910992543.9

(51) Int. Cl. G02F 1/1362; G02F 1/1343

(52) U.S. Cl. CPC G02F 1/136209; G02F 1/134309; G02F 1/136222; G02F 1/136286; G02F 1/136218

(57) ABSTRACT

A substrate is provided, which includes a base, a light shielding metal layer, a signal line layer, and a pixel electrode layer. The light shielding metal layer is located on the base and includes patterned shield electrodes. The signal line layer includes patterned data lines. The pixel electrode layer includes patterned pixel electrodes. Furthermore, a superposition region is present on an orthogonal projection of the data lines on the base and an orthogonal projection of the shield electrodes on the base.

### FIELD OF INVENTION

The present disclosure relates to the field of display technology, and particularly relates to a substrate and a liquid crystal display panel.

### BACKGROUND OF INVENTION

Thin film transistor liquid crystal displays (TFT-LCDs) are widely used on products of mobile phones, tablet PCs, televisions, etc. Generally speaking, a thin film transistor liquid crystal display is to sandwich a liquid crystal layer between a top substrate and a bottom substrate which are parallel to each other, and to apply a voltage on electrodes of the top and the bottom substrates to generate an electric field between the two substrates for controlling a tilting direction of liquid crystal molecules in the liquid crystal layer, thereby displaying different images. With growing acceptance of liquid crystal display devices in the market, requirements on quality of liquid crystal display devices from consumers have also become higher, for example, viewing angles, contrast, image response speed, power consumption, etc.

For TFT-LCD panels with large dimensions and high resolutions, improving a penetration rate of the panels is conducive to reducing power consumption of the panels. Presently, one of the most effective methods for improving penetration rate is to increase an aperture ratio of the panels, which is an effective area of light penetration of pixels. In order to prevent light leakage between a signal line and a pixel electrode, a large overlapping area is generally present between a black matrix and the pixel electrode, which greatly limits an increase of the aperture ratio.

In summary, display panels of the prior art, in which due to the presence of a large overlapping area between the black matrix and the pixel electrodes, have problems of a low aperture ratio and higher power consumption of the display panel. Therefore, it is necessary to improve the defect.

The prior art has the technical problem in which due to the presence of a large overlapping area between the black matrix and the pixel electrode, problems of a low aperture ratio and higher power consumption of the display panels are caused.

### SUMMARY OF INVENTION

In order to solve the problems mentioned above, the present disclosure provides the technical solutions as follows:

An embodiment of the present disclosure provides a substrate, including a base, a light shielding metal layer, a signal line layer, and a pixel electrode layer. The light shielding metal layer is located on the base and including patterned shield electrodes. The signal line layer includes patterned data lines. The pixel electrode layer includes patterned pixel electrodes. Furthermore, a superposition region is present on an orthogonal projection of the data lines on the base and an orthogonal projection of the shield electrodes on the base.

In the substrate provided by an embodiment of the present disclosure, the superposition region is present on an orthogonal projection of a same data line on the base and an orthogonal projection of two of the shield electrodes on the base.

In the substrate provided by an embodiment of the present disclosure, a superposition region is present on the orthogonal projection of the shield electrodes on the base and an orthogonal projection of the pixel electrodes on the base, and a superposition area between the orthogonal projection of the shield electrodes on the base and the orthogonal projection of the data lines on the base is greater than a superposition area between the orthogonal projection of the shield electrodes on the base and the orthogonal projection of the pixel electrodes on the base.

In the substrate provided by an embodiment of the present disclosure, a superposition area between the orthogonal projection of the shield electrodes on the base and the orthogonal projection of the data lines on the base takes up any one of a value between 30% and 40% of a total area of the data lines.

In the substrate provided by an embodiment of the present disclosure, the shield electrodes are disposed on a same layer.

In the substrate provided by an embodiment of the present disclosure, the orthogonal projection of the data lines on the base is located in the orthogonal projection of the shield electrodes on the base.

In the substrate provided by an embodiment of the present disclosure, the orthogonal projection of the shield electrodes on the base does not overlap with an orthogonal projection of the pixel electrodes on the base.

In the substrate provided by an embodiment of the present disclosure, the shield electrodes include a first shield electrode and a second shield electrode, and the first shield electrode is located on a side of the data lines away from the pixel electrodes, and the second shield electrode is located between two of the pixel electrodes.

In the substrate provided by an embodiment of the present disclosure, the shield electrodes include a third shield electrode and a fourth shield electrode, and the third shield electrode is located on a side of the data lines away from the pixel electrodes, and the fourth shield electrode is located between the data lines and the third shield electrode.

The present disclosure provides a liquid crystal display panel, including a first substrate and a second substrate, and the second substrate and the first substrate are aligned to form a cell. The first substrate includes a base, a light shielding metal layer, a signal line layer, and a pixel electrode layer. The light shielding metal layer is located on the base and includes patterned shield electrodes. The signal line layer includes patterned data lines. The pixel electrode layer includes patterned pixel electrodes.

Furthermore, a superposition region is present on an orthogonal projection of the data lines on the base and an orthogonal projection of the shield electrodes on the base.

In the liquid crystal display panel provided by the embodiment of the present disclosure, a superposition region is present on an orthogonal projection of a same data line on the base and an orthogonal projection of two of the shield electrodes on the base.

In the liquid crystal display panel provided by an embodiment of the present disclosure, a superposition region is present on the orthogonal projection of the shield electrodes on the base and an orthogonal projection of the pixel electrode on the base, and a superposition area between the orthogonal projection of the shield electrodes on the base and the orthogonal projection of the data lines on the base is greater than a superposition area between the orthogonal projection of the shield electrodes on the base and the orthogonal projection of the pixel electrode on the base.

In the liquid crystal display panel provided by an embodiment of the present disclosure, a superposition area between the orthogonal projection of the shield electrodes on the base and the orthogonal projection of the data lines on the base takes up any one of a value between 30% and 40% of a total area of the data lines.

In the liquid crystal display panel provided by an embodiment of the present disclosure, the shield electrodes are disposed on a same layer.

In the liquid crystal display panel provided by an embodiment of the present disclosure, the orthogonal projection of the data lines on the base is located in the orthogonal projection of the shield electrodes on the base.

In the liquid crystal display panel provided by an embodiment of the present disclosure, the orthogonal projection of the shield electrodes on the base does not overlap an orthogonal projection of the pixel electrodes on the base.

In the liquid crystal display panel provided by an embodiment of the present disclosure, the shield electrodes include a first shield electrode and a second shield electrode, and the first shield electrode is located on a side of the data lines away from the pixel electrodes, and the second shield electrode is located between two of the pixel electrodes.

In the liquid crystal display panel provided by an embodiment of the present disclosure, the shield electrodes include a third shield electrode and a fourth shield electrode, and the third shield electrode is located on a side of the data lines away from the pixel electrodes, and the fourth shield electrode is located between the data lines and the third shield electrode.

The beneficial effect of the present disclosure is that a substrate is provided by an embodiment of the present disclosure, and by increasing the overlapping area of the shield electrodes and the data lines, a shielding level of the electric field of the shield electrode to the data lines is improved, so that a level of light leakage and a width are reduced. The reduction of the level of light leakage and the width is that a width of a region of the black matrix blocking the light leakage is reduced, thereby reducing the overlapping area of the black matrix and the pixel electrodes, and thereby improving the aperture ratio of the display panel, that is, the penetration rate of the display panel is improved, thereby lowering the power consumption of the display panel.

### DESCRIPTION OF DRAWINGS

In order to more clearly illustrate embodiments or the technical solutions of the present disclosure, the accompanying figures of the present disclosure required for illustrating embodiments or the technical solutions of the present disclosure will be described in brief. Obviously, the accompanying figures described below are only part of the embodiments of the present disclosure, from which those skilled in the art can derive further figures without making any inventive efforts.

FIG. 1 is a basic structural diagram of a substrate provided by a first embodiment of the present disclosure.

FIG. 2 is a basic structural diagram of a substrate provided by a second embodiment of the present disclosure.

FIG. 3 is a basic structural diagram of a substrate provided by a third embodiment of the present disclosure.

FIG. 4 is a basic structural diagram of a substrate provided by a fourth embodiment of the present disclosure.

FIG. 5 is a basic structural diagram of a liquid crystal display panel provided by the present disclosure.

FIG. 6 is another basic structural diagram of the liquid crystal display panel provided by the present disclosure.

### DETAILED DESCRIPTION OF PREFERRED EMBODIMENTS

The technical solutions in the embodiments of the present disclosure are clearly and completely described in the following with reference to the accompanying drawings in the embodiments of the present disclosure. Obviously, the described embodiments are only part of the embodiments of the present disclosure, and are not all embodiments of the present disclosure. All other embodiments obtained by those skilled in the art based on the embodiments of the present disclosure without creative efforts are within the scope of the present disclosure.

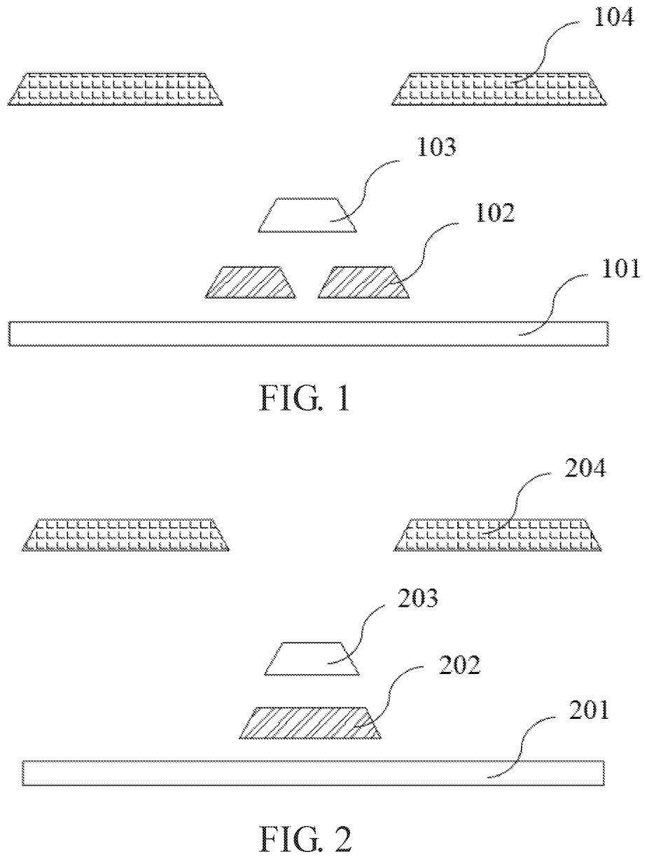

Illustrated in FIG. 1 is a basic structural diagram of a substrate provided by a first embodiment of the present disclosure. From FIG. 1, components of the present disclosure and relative positional relationships between each of the components can be directly seen. The substrate includes a base 101, a light shielding metal layer, a signal line layer, and a pixel electrode layer. The light shielding metal layer is located on the base 101 and is patterned to form shield electrodes 102. The signal line layer is patterned to form data lines 103. The pixel electrode layer is patterned to form pixel electrodes 104. Furthermore, a superposition region is present on an orthogonal projection of the data lines 103 on the base 101 and an orthogonal projection of the shield electrodes 102 on the base 101.

It should be noted that because a voltage difference is present between the data lines 103 and the pixel electrodes 104, one electric field is formed; and under effect of the electric field, deflection of liquid crystals between the data lines 103 and the pixel electrodes 104 occurs, which causes light leakage. The present disclosure shields the electric field of the data lines 103 through adding shield electrodes 102. Specifically, the shield electrodes 102 and the data lines 103 are equal to one power supply, and a voltage difference is present between the two (a voltage of the shield electrodes 102 less than a voltage of the data lines 103), which forms the electric field. A direction of electric field lines is pointed from the data lines 103 toward the shield electrodes 102, and a direction of the electric field of the data lines 103 is downward, which weakens the electric field between the data lines 103 and the pixel electrodes 104, so that a level of light leakage and a width are reduced. The reduction of the level of light leakage and the width is that a width of a region of the black matrix blocking the light leakage is reduced, thereby reducing the overlapping area of the black matrix and the pixel electrodes, and thereby improving the aperture ratio of the display panel, that is, the penetration rate of the display panel is improved, thereby lowering the power consumption of the display panel.

In an embodiment, a superposition region is present on an orthogonal projection of the same data line on the base 101 and an orthogonal projection of two of the shield electrodes on the base 101; and the shield electrodes are disposed on a same layer, that is, two of the shield electrodes are respectively located on a left side and a right side of the same data line 103. Furthermore, two of the shield electrodes has the superposition region with the same data line 103, that is, two of the shield electrodes are located on regions corresponding to gaps between the pixel electrodes and the data line 103. The superposition region is present on the orthogonal projection of the shield electrodes 102 on the base 101 and an orthogonal projection of the pixel electrodes 104 on the base 101, and a superposition area between the orthogonal projection of the shield electrodes 102 on the base 101 and the orthogonal projection of the data lines 103 on the base 101 is greater than a superposition area between the orthogonal projection of the shield electrodes 102 on the base 101 and the orthogonal projection of the pixel electrodes 104 on the base 101.

In an embodiment, a material of the shield electrodes 102 is a metal of copper or aluminum. The superposition area between the orthogonal projection of the shield electrodes 102 on the base 101 and the orthogonal projection of the data lines 103 on the base 101 takes up any one of a value between 30% and 40% of a total area of the data lines 103.

Illustrated in FIG. 2 is a basic structural diagram of a substrate provided by a second embodiment of the present disclosure. From FIG. 2, components of the present disclosure and relative positional relationships between each of the components can be directly seen. The substrate includes a base 201, a light shielding metal layer, a signal line layer, and a pixel electrode layer. The light shielding metal layer is located on the base 201 and is patterned to form shield electrodes 202. The signal line layer is patterned to form data lines 203. The pixel electrode layer is patterned to form pixel electrodes 204. Furthermore, a superposition region is present on an orthogonal projection of the data lines 203 on the base 201 and an orthogonal projection of the shield electrodes 202 on the base 201. Specifically, the orthogonal projection of the data lines 203 on the base 201 is located in the orthogonal projection of the shield electrodes 202 on the base 201.

It should be noted that the orthogonal projection of the data lines 203 on the base 201 is located in the orthogonal projection of the shield electrodes 202 on the base 201, that is, the shield electrodes 202 are located right below the data lines 203, so the shielding effect of the electric field of the shield electrodes 202 to the data lines 202 can be enhanced, thereby reducing the electric field between the data lines 203 and the pixel electrodes 204, which reduces a level of light leakage and a width. The reduction of the level of light leakage and the width is that a width of a region of the black matrix blocking the light leakage is reduced, thereby reducing the overlapping area of the black matrix and the pixel electrodes, and thereby improving the aperture ratio of the display panel, that is, the penetration rate of the display panel is improved, thereby lowering the power consumption of the display panel.

In an embodiment, the orthogonal projection of the shield electrodes 202 on the base 101 does not overlap with an orthogonal projection of the pixel electrodes 204 on the base 201; and the orthogonal projection area of the shield electrodes 202 on the base 201 is greater than the orthogonal projection area of the data lines 203 on the base 201, that is, part of the shield electrodes are located on regions corresponding to gaps between the pixel electrodes and the data lines 203. This part of the shield electrodes can not only shield light, but also serve a certain shielding effect to a common electrode above and can also reduce light leakage.

In an embodiment, the shield electrodes 202 can be manufactured from a gate electrode layer, and there is no need to separately manufacture a light shielding metal layer, which can reduce technical processes and save cost, and a thickness of the display panel finally manufactured can be correspondingly reduced.

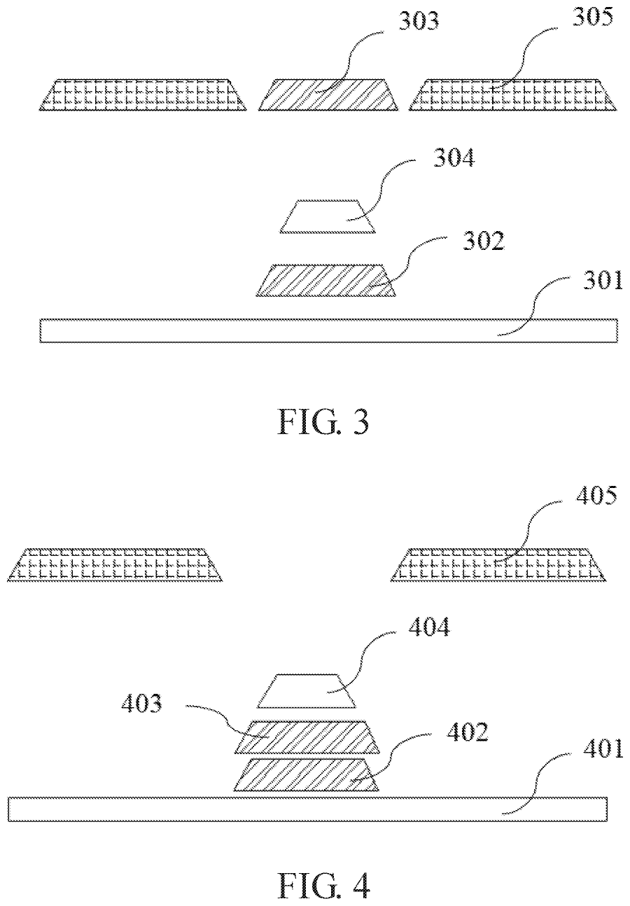

Illustrated in FIG. 3 is a basic structural diagram of a substrate provided by a third embodiment of the present disclosure. From FIG. 3, components of the present disclosure and relative positional relationships between each of the components can be directly seen. The substrate includes a base 301, a light shielding metal layer, a signal line layer, and a pixel electrode layer. The light shielding metal layer is located on the base 301 and is patterned to form shield electrodes. The signal line layer is patterned to form data lines 304. The pixel electrode layer is patterned to form pixel electrodes 305. Furthermore, a superposition region is present on an orthogonal projection of the data lines 304 on the base 301 and an orthogonal projection of the shield electrodes on the base 301. Specifically, the orthogonal projection of the data lines 304 on the base 301 is located in the orthogonal projection of the shield electrodes on the base 301.

Furthermore, the shield electrodes include a first shield electrode 302 and a second shield electrode 303. The first shield electrode 302 is located on a side of the data lines 304 away from the pixel electrodes 305, and the second shield electrode 303 is located between two of the pixel electrodes.

In an embodiment, the first shield electrode 302 is used for shielding the electric field of the data lines 304; the second shield electrode 303 is used for shielding an electric field on a horizontal direction between the pixel electrodes; and the second shield electrode 303 is also able to be used for shielding the electric field of the common electrode above and for shielding light.

Illustrated in FIG. 4 is a basic structural diagram of a substrate provided by a fourth embodiment of the present disclosure. From FIG. 4, components of the present disclosure and relative positional relationships between each of the components can be directly seen. The substrate includes a base 401, a light shielding metal layer, a signal line layer, and a pixel electrode layer. The light shielding metal layer is located on the base 401 and is patterned to form shield electrodes. The signal line layer is patterned to form data lines 404. The pixel electrode layer is patterned to form pixel electrodes 405. Furthermore, a superposition region is present on an orthogonal projection of the data lines 404 on the base 401 and an orthogonal projection of the shield electrodes on the base 401. Specifically, the orthogonal projection of the data lines 404 on the base 401 is located in the orthogonal projection of the shield electrodes on the base 401.

Furthermore, the shield electrodes include a third shield electrode 402 and a fourth shield electrode 403. The third shield electrode 402 is located on a side of the data lines 404 away from the pixel electrodes 405, and the fourth shield electrode is located between the data lines 404 and the third shield electrode 402.

In an embodiment, the third shield electrode 402 is manufactured from patterning the light shielding metal layer and is used for shielding light, and the fourth shield electrode 403 is manufactured from the gate electrode layer and is used for shielding the electric field of the data lines 404. A section of the projection of the fourth shield electrode 403 which does not overlap with the data lines 404 and the pixel electrodes can also be used to shield the electric field of the common electrode above and to shield light.

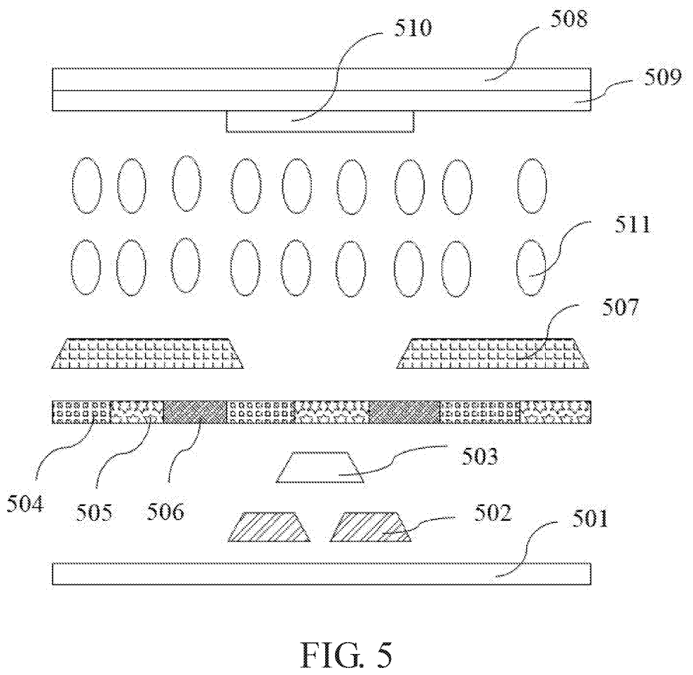

Illustrated in FIG. 5 is a basic structural diagram of a liquid crystal display panel provided by the present disclosure. The liquid crystal display panel includes a first substrate, a second substrate, and liquid crystals 511 located between the first substrate and the second substrate, and the second substrate and the first substrate are aligned to form a cell. The first substrate includes a base 501, a light shielding metal layer, a signal line layer, a color resist layer, and a pixel electrode layer. The light shielding metal layer is located on the base 501 and is patterned to form shield electrodes 502. The signal line layer is patterned to form data lines 503. The color resist layer includes a red color resist 504, a green color resist 505, and a blue color resist 506. The pixel electrode layer is patterned to form pixel electrodes 507. Furthermore, a superposition region is present on an orthogonal projection of the data lines 503 on the base 501 and an orthogonal projection of the shield electrodes 502 on the base 501.

In an embodiment, the second substrate includes a second base 508, a common electrode 509, and a black matrix 510. The common electrode 509 is disposed on the second substrate 508 and covers the second substrate 508 with an entire surface. The black matrix 510 is disposed on a side of the common electrode 509 away from the second base 508 and corresponds to a region between two of the pixel electrodes.

It should be noted that because a voltage difference is present between the data lines 503 and the pixel electrodes 507, one electric field is formed; and under effect of the electric field, deflection of liquid crystals between the data lines 503 and the pixel electrodes 507 occurs, which causes light leakage. The present disclosure shields the electric field of the data lines 503 through adding shield electrodes 502. Specifically, the shield electrodes 502 and the data lines 503 are equal to one power supply, and a voltage difference is present between the two (a voltage of the shield electrodes 502 is less than a voltage of the data lines 503), which forms the electric field. A direction of electric field lines is pointed from the data lines 503 toward the shield electrodes 502, and a direction of the electric field of the data lines 503 is downward, which weakens the electric field between the data lines 503 and the pixel electrodes 507, thereby reducing a level of light leakage and a width. The reduction of the level of light leakage and the width is that a width of a region of the black matrix 510 blocking the light leakage is reduced, thereby reducing the overlapping area of the black matrix 510 and the pixel electrodes 507, and thereby improving the aperture ratio of the display panel, that is, the penetration rate of the display panel is improved, thereby lowering the power consumption of the display panel.

In an embodiment, a section of the orthogonal projection of the shield electrodes 502 on the base 501 which does not overlap with the orthogonal projection of the data lines 503 and the pixel electrodes 507 on the base 501 is able to serve an effect of shielding the common electrode 509 above and shielding light, and is also able to reduce light leakage.

It should be noted that in the liquid crystal display panel provided by this embodiment, the configuration method of the shield electrodes 502 is not only as the configuration method illustrated in FIG. 5, but can also be any configuration method as illustrated in FIG. 2 to FIG. 4.

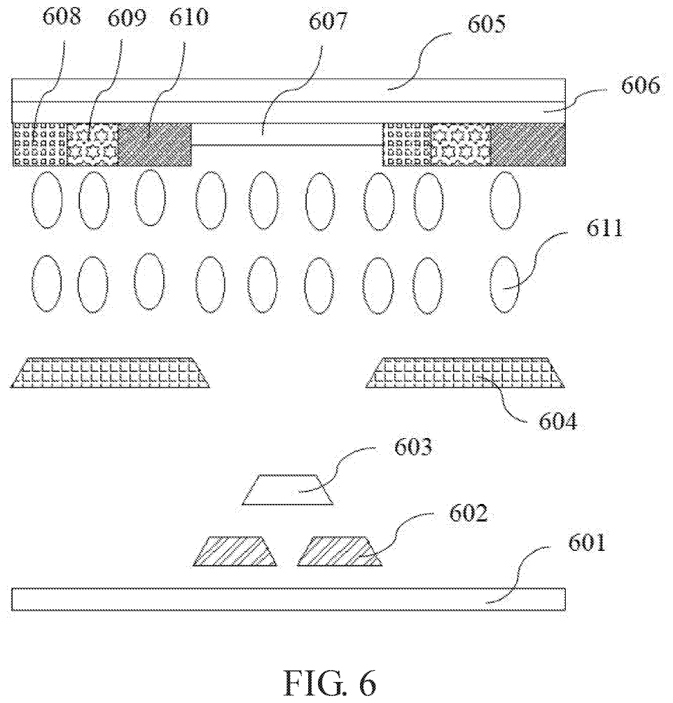

Illustrated in FIG. 6 is another basic structural diagram of the liquid crystal display panel provided by the present disclosure. The liquid crystal display panel includes a first substrate, a second substrate, and liquid crystals 611 located between the first substrate and the second substrate, and the second substrate and the first substrate are aligned to form a cell. The first substrate is an array substrate. The array substrate includes a base 601, a light shielding metal layer, a signal line layer, and a pixel electrode layer. The light shielding metal layer is located on the base 601 and is patterned to form shield electrodes 602. The signal line layer is patterned to form data lines 603. The pixel electrode layer is patterned to form pixel electrodes 604. Furthermore, a superposition region is present on an orthogonal projection of the data lines 603 on the base 601 and an orthogonal projection of the shield electrodes 602 on the base 601.

In an embodiment, the second substrate is a color film substrate. The color film substrate includes a second base 605, a common electrode 606, color resists, and a black matrix 607. The common electrode 606 is disposed on the second base 605 and covers the second base 605 with an entire surface. The color resists include a red color resist 608, a green color resist 609, and a blue color resist 610, and the color resists are disposed to be corresponding to the pixel electrodes 604, that is, a light extraction region. The black matrix 607 is disposed on a side of the common electrode 606 away from the second base 605 and is located on a region of intervals of the color resists, that is, a light shielding region.

It should be noted that because a voltage difference is present between the data lines 603 and the pixel electrodes 604, one electric field is formed; and under effect of the electric field, deflection of liquid crystals between the data lines 603 and the pixel electrodes 604 occurs, which causes light leakage. The present disclosure shields the electric field of the data lines 603 through adding shield electrodes 602. Specifically, the shield electrodes 602 and the data lines 603 are equal to one power supply, and a voltage difference is present between the two (a voltage of the shield electrodes 602 is less than a voltage of the data lines 603), which forms the electric field. A direction of electric field lines is pointed from the data lines 603 toward the shield electrodes 602, and a direction of the electric field of the data lines 603 is downward, which weakens the electric field between the data lines 603 and the pixel electrodes 604, thereby reducing a level of light leakage and a width. The reduction of the level of light leakage and the width is that a width of a region of the black matrix 607 blocking the light leakage is reduced, thereby reducing the overlapping area of the black matrix 607 and the pixel electrodes 604, and thereby improving the aperture ratio of the display panel, that is, the penetration rate of the display panel is improved, thereby lowering the power consumption of the display panel.

In an embodiment, a section of the orthogonal projection of the shield electrodes 602 on the base 601 which does not overlap with the orthogonal projection of the data lines 603 and the pixel electrodes 604 on the base 601 is able to serve an effect of shielding the common electrode 606 above and shielding light, and is also able to reduce light leakage.

It should be noted that in the liquid crystal display panel provided by this embodiment, the configuration method of the shield electrodes 602 is not only as the configuration method illustrated in FIG. 6, but can also be any configuration method as illustrated in FIG. 2 to FIG. 4.

In summary, a substrate and a liquid crystal display are provided by the present disclosure, and by increasing an overlapping area of shield electrodes and data lines to improve a shielding level of an electric field of the shield electrodes to the data lines, a level of light leakage and a width are reduced; and a reduction of the level of light leakage and the width is that a width of a region of a black matrix blocking light leakage is reduced, thereby reducing an overlapping area of the black matrix and pixel electrodes, and thereby improving an aperture ratio of the display panel, that is, a penetration rate of the display panel is improved, thereby lowering power consumption of the display panel, which solves the technical problem of the display panel in the prior art, in which due to a presence of a large overlapping area between the black matrix and the pixel electrodes, problems of a low aperture ratio and higher power consumption of the display panel are caused.

The substrate and the liquid crystal display panel provided by the present disclosure are described in detail above. It should be understood that the exemplary embodiments described herein should be considered as descriptive, and is used for understanding the method of the present disclosure and its main idea, and is not intended to limit the present disclosure.

What is claimed is:

1. A substrate, comprising:
a base;
a light shielding metal layer located on the base and comprising patterned shield electrodes;
a signal line layer comprising patterned data lines;
a pixel electrode layer comprising patterned pixel electrodes; and
a superposition region present on an orthogonal projection of the data lines on the base and an orthogonal projection of the shield electrodes on the base.

2. The substrate as claimed in claim 1, wherein the superposition region is present on an orthogonal projection of a same data line on the base and the orthogonal projection of two of the shield electrodes on the base.

3. The substrate as claimed in claim 2, wherein a superposition region is present on the orthogonal projection of the shield electrodes on the base and an orthogonal projection of the pixel electrodes on the base, and a superposition area between the orthogonal projection of the shield electrodes on the base and the orthogonal projection of the data lines on the base is greater than a superposition area between the orthogonal projection of the shield electrodes on the base and the orthogonal projection of the pixel electrodes on the base.

4. The substrate as claimed in claim 2, wherein a superposition area between the orthogonal projection of the shield electrodes on the base and the orthogonal projection of the data lines on the base takes up any one of a value between 30% and 40% of a total area of the data lines.

5. The substrate as claimed in claim 2, wherein the shield electrodes are disposed on a same layer.

6. The substrate as claimed in claim 1, wherein the orthogonal projection of the data lines on the base is located in the orthogonal projection of the shield electrodes on the base.

7. The substrate as claimed in claim 6, wherein the orthogonal projection of the shield electrodes on the base does not overlap with an orthogonal projection of the pixel electrodes on the base.

8. The substrate as claimed in claim 6, wherein the shield electrodes comprise a first shield electrode and a second shield electrode, the first shield electrode is located on a side of the data lines away from the pixel electrodes, and the second shield electrode is located between two of the pixel electrodes.

9. The substrate as claimed in claim 6, wherein the shield electrodes comprise a third shield electrode and a fourth shield electrode, the third shield electrode is located on a side of the data lines away from the pixel electrodes, and the fourth shield electrode is located between the data lines and the third shield electrode.

10. A liquid crystal display panel, comprising a first substrate and a second substrate, the second substrate and the first substrate are aligned to form a cell, and the first substrate comprising:
a base;
a light shielding metal layer located on the base and comprising patterned shield electrodes;
a signal line layer comprising patterned data lines;
a pixel electrode layer comprising patterned pixel electrodes; and
a superposition region present on an orthogonal projection of the data lines on the base and an orthogonal projection of the shield electrodes on the base.

11. The liquid crystal display panel as claimed in claim 10, wherein the superposition region is present on an orthogonal projection of a same data line on the base and an orthogonal projection of two of the shield electrodes on the base.

12. The liquid crystal display panel as claimed in claim 11, wherein a superposition region is present on the orthogonal projection of the shield electrodes on the base and an orthogonal projection of the pixel electrodes on the base, and a superposition area between the orthogonal projection of the shield electrodes on the base and the orthogonal projection of the data lines on the base is greater than a superposition area between the orthogonal projection of the shield electrodes on the base and the orthogonal projection of the pixel electrodes on the base.

13. The liquid crystal display panel as claimed in claim 11, wherein a superposition area between the orthogonal projection of the shield electrodes on the base and the orthogonal projection of the data lines on the base takes up any one of a value between 30% and 40% of a total area of the data lines

14. The liquid crystal display panel as claimed in claim 11, wherein the shield electrodes are disposed on a same layer.

15. The liquid crystal display panel as claimed in claim 10, wherein the orthogonal projection of the data lines on the base is located in the orthogonal projection of the shield electrodes on the base.

16. The liquid crystal display panel as claimed in claim 15, wherein the orthogonal projection of the shield electrodes on the base does not overlap with an orthogonal projection of the pixel electrodes on the base.

17. The liquid crystal display panel as claimed in claim 15, wherein the shield electrodes comprise a first shield electrode and a second shield electrode, the first shield electrode is located on a side of the data lines away from the pixel electrodes, and the second shield electrode is located between two of the pixel electrodes.

18. The liquid crystal display panel as claimed in claim 15, wherein the shield electrodes comprise a third shield electrode and a fourth shield electrode, the third shield electrode is located on a side of the data lines away from the pixel electrodes, and the fourth shield electrode is located between the data lines and the third shield electrode.
